(19) United States
(12) Patent Application Publication
(10) Pub. No.: US 2019/0245482 A1
(43) Pub. Date: Aug. 8, 2019

(54) PHOTOVOLTAIC DEVICE

(71) Applicant: Doo III KIM, Yangju-si, Gyeonggi-do (KR)

(72) Inventor: Doo Ill KIM, Yangju-si (KR)

(21) Appl. No.: 16/309,834

(22) PCT Filed: Oct. 20, 2016
(86) PCT No.: PCT/KR2016/011829

§ 371 Date: Dec. 13, 2018

(30) Foreign Application Priority Data
Sep. 9, 2016 (KR) 10-2016-0116204

(51) Int. Cl. H02S 40/38; H02J 7/35; H02M 7/48

(52) U.S. Cl. CPC H02S 40/38; H02M 7/48; H02J 7/35

(57) ABSTRACT

Provided is a photovoltaic device comprising: light concentration unit for concentrating incident solar energy; a solar cell module converting the concentrated solar energy into electrical energy and outputting direct current (DC) power; a light amount detection unit for detecting the light amount of the solar energy; a battery module charged by receiving the DC power; a power detection unit for detecting the DC power; a first comparator comparing the DC power with a charged voltage of the battery module and outputting a first comparison result signal; a second comparator, which compares the detected light amount of the solar energy with reference light amount data indicating the light amount sufficient enough to be converted into electrical energy and outputs a second comparison result signal; a third comparator comparing the charged voltage of the battery module with overdischarge reference voltage data and outputting a third comparison result signal; a fourth comparator comparing the charged voltage of the battery module with overcharge reference voltage data and outputting a fourth comparison result signal; an auxiliary power generation unit, which operates when the light amount of the solar energy is less than the reference light amount data, rotates an AC motor or a DC motor by means of the DC power, decelerates or accelerates the number of revolutions of motive power, and generates and outputs auxiliary electrical energy; a distribution controller for controlling the supply and cut-off of the DC power from the solar cell module to the battery module; and an AC output driver converting charged power of the battery module or the DC power from the solar cell module into AC power having a frequency of 400 Hz to 1200 Hz and outputting the AC power to a load.

### TECHNICAL FIELD

The present invention relates to a photovoltaic device and more specifically, to a photovoltaic device capable of generating electricity using solar energy.

### DESCRIPTION OF THE RELATED ART

Research into technologies for generating electricity with natural resources such as solar power, wind power and tidal power etc. has been performed worldwide. Many of them have been commercialized. However, generating electricity using natural resources is heavily dependent on geographic locations. That is, an area with abundant sunlight is appropriate for generating electricity using solar energy, while an area with abundant wind is appropriate for generating electricity using wind energy.

Systems for generating electricity with solar energy have been developed. Additionally, various types of studies have been underway to improve performance of solar cell modules and have produced good results. However, the question is that a constant amount of electricity has to be produced regardless of weather and time because the efficiency of solar cells is greatly affected by the amount of sunlight. When electricity generated by a solar cell is not enough to charge a storage battery due to a small amount of sunlight, the efficiency of a photovoltaic system is lowered.

Therefore, there is a need to develop a system that can use even a small amount of electricity generated by a solar cell with a small amount of sunlight.

### DETAILED DESCRIPTION OF THE INVENTION

### Technical Problems

As a means to solve such problems, the present invention is directed to providing a photovoltaic device that can generate electricity using an auxiliary power generation unit. even when there is a small amount of sunlight.

### Technical Solutions

As a means to achieve the above-described purposes, a photovoltaic device according to the present invention includes: a light concentration unit for concentrating incident solar energy; a solar cell module converting the solar energy concentrated in the light concentration unit into electrical energy and outputting direct current (DC) power; a light amount detection unit for detecting a light amount of the solar energy; a battery module charged by receiving the DC power from the solar cell module; a power detection unit for detecting the DC from the solar cell module; a first comparator comparing the DC power from the solar cell module detected by the power detection unit with a charged voltage of the battery module and outputting a first comparison result signal; a second comparator comparing light amount of the solar energy detected by the light amount detection unit with reference light amount data indicating a light amount enough to be converted into the electrical energy and outputting a second comparison result signal; a third comparator comparing the charged voltage of the battery module with over-discharge reference voltage data and outputting a third comparison result signal; a fourth comparator comparing a charged voltage of the battery module with over-charge reference voltage data and outputting a fourth comparison result signal; an auxiliary power generation unit, which operates when a light amount of the solar energy is less than the reference light amount data, rotates an AC motor or a DC motor by means of the DC power, decelerates or accelerates the number of revolutions of motive power, and generates and outputs auxiliary electrical energy; a distribution controller for controlling the supply, and cut-off of the DC power to the battery module according to the first, second, third and fourth comparison result signals; and an AC output driver converting charged power of the battery or the DC power from the solar cell module into alternating current (AC) power having a frequency of 400 Hz to 1200 Hz and outputting the AC power to a load.

When the detected DC power is higher than a charged voltage of the battery module, the distribution controller may control the supply of the DC power from the solar cell module to the battery module, and when the detected DC power is lower than or equal to a charged voltage of the battery module, the distribution controller may control the cut-off of the DC power from the solar cell module to the battery module.

When the detected light amount of the solar energy is more than or equal to the reference light amount data, the distribution controller may control the supply of the DC power from the solar cell module to the battery module, and when the detected light amount of the solar energy is less than the reference light amount data, the distribution controller may control the cut-off of the DC power from the solar cell module to the battery module.

When the charged voltage of the battery module is lower than or equal to the over-discharge reference voltage data, the distribution controller may control the supply of the DC power from the solar cell module to the battery module, and when the charged voltage of the battery module is less than the over-discharge reference voltage data, the distribution controller may control the cut-off of the DC power from the solar cell module to the battery module.

When a charged voltage of the battery module is less than the over-charge reference voltage data, the distribution controller may control the supply of the DC power to the battery module, and when a charged voltage of the battery module is more than or equal to the over-charge reference voltage data, the distribution controller may control the cut-off of the DC power to the battery module.

The photovoltaic device may further include a memory that stores the reference light amount data, the over-discharge reference voltage data, and the over-charge reference voltage data.

### Advantageous Effects

According to the present invention, when the light amount of solar energy is more than or equal to reference light amount data, the concentrated solar energy is converted into electric energy so as to charge a battery with AC power and to supply the AC power to a load, and when the light amount of solar energy is less than reference light amount data, an auxiliary power generation unit operates so as to rotate an AC motor or a DC motor and to decelerate or accelerate the number of revolutions of motive power, thereby making it possible to generate auxiliary power. Thus, even when a small amount or electricity is generated by a solar cell module, the present invention can use the electricity for a charge and output and can generate high-frequency power, thereby minimizing loss that is caused while electricity is transmitted.

Efficiency in the conversion from a battery module to a load has been tested by connecting input to a battery module terminal and connecting output to a load with the capacity of 7.32 W at Korea Testing Certification. The result shows at the rate of efficiency in the conversion from a battery module to a load is 95.98%.

### BRIEF DESCRIPTION OF THE DRAWINGS

FIG. 1 is a block diagram illustrating a configuration of photovoltaic device according to an embodiment of the present invention.

### BEST MODE FOR CARRYING OUT THE INVENTION

Preferred embodiments of the present invention will be described with reference to the following detailed description of the embodiments. However, the present invention may be embodied in many different forms and should not be construed as being limited to the embodiments set forth herein. Rather, these embodiments are provided so that the present invention will be through and complete and will fully convey the concept of the present invention to one of ordinary skill in the art. Further like reference numerals denote like elements throughout the specification.

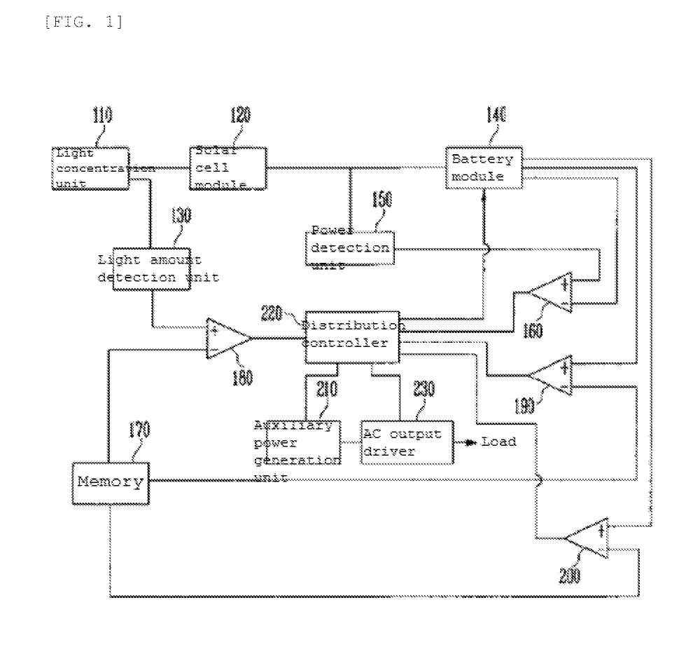

FIG. 1 is a block diagram illustrating a configuration of a photovoltaic device according to an embodiment of the present invention.

With reference to FIG. 1, a photovoltaic device according to an embodiment of the present invention includes a light concentration unit 110, a solar cell module 120, light amount detection unit 130, a battery module 140, a power detection unit 150, a first comparator 160, a memory 170, a second comparator 180, a third comparator 190, a fourth comparator 200, an auxiliary power generation unit 210, a distribution controller 220, and an AC output driver 230.

The light concentration unit 110 concentrates incident solar energy, the solar cell module 120 converts the solar energy concentrated by the light concentration unit 110 into electrical energy and outputs direct current (DC) power, and the light amount detection unit 130 detects the light amount of the solar energy.

The battery module 140 is charged by receiving the DC power from the solar cell module 120, and the power detection unit 150 detects the DC power from the solar cell module 120. The first comparator 160 compares the DC power from the solar cell module 120 detected by the power detection unit 150 with a charged voltage of the battery module 140 and outputs a first comparison result signal.

The memory 170 stores reference light amount data indicating the light amount sufficient enough to be converted into electrical energy, over-discharge reference voltage data, and over-charge reference voltage data. The second comparator 180 compares the light amount of the solar energy detected by the light amount detection unit 130 with the reference light amount data stored in the memory 170 and outputs a second comparison result signal.

The third comparator 190 compares the charged voltage of the battery module 140 with the over-discharge reference voltage data stored in the memory and outputs a third comparison result signal, and the fourth comparator 200 compares the charged voltage of the battery module 140 with the over-charge reference voltage data stored in the memory 170 and outputs a fourth comparison result signal.

The auxiliary power generation unit 210 operates when the light amount of the solar energy is less than the reference light amount data stored in the memory 170, rotates an AC motor (invisible) or a DC motor (invisible) by means of the DC power from the distribution controller 220, decelerates or accelerates the number of revolutions of motive power, generates auxiliary electrical energy and outputs the same to the distribution controller 220.

The distribution controller 220 controls the supply and cut-off of the DC power from the solar cell module 120 to the battery module 140 according to the first comparison result signal from the first comparator 160.

The distribution controller 220 controls the supply and cut-off of the DC power from the solar cell module 120 to the battery module 140 according to the second comparison result signal from the second comparator 170.

The distribution controller 220 controls the supply and cut-off of the DC power from the solar cell module 120 to the battery module 140 according to the third comparison result signal so as to prevent the over-discharge of to the battery module 140.

The distribution controller 220 controls the supply and cut-off of the DC power from the solar cell module 120 to the battery module 140 according to the fourth comparison result signal so as to prevent the over-charge of the battery module 140.

When the detected DC power is higher than the charged voltage of the battery module 140, the distribution controller 220 controls the supply of the DC power from the solar cell module 120 to the battery module 140. When the detected DC power is lower than or equal to the charged voltage of the battery module 140, the distribution controller 220 controls the cut-off of the DC power from the solar cell module 120 to the battery module 140.

When the detect light amount of the solar energy is more than or equal to the reference light amount data stored in the memory 170, the distribution controller 220 controls the supply of the DC power from the solar cell module 120 to the battery module 140. When the detected light amount of the solar energy is less than the reference light amount data stored in the memory 170, the distribution controller 220 controls the cut-off the DC power from the solar cell module 120 to the battery module 140.

When the charged voltage of the battery module 140 is lower than or equal to the over-discharge reference voltage data stored in the memory 170, the distribution controller 220 controls the supply of the DC power from the solar cell module 120 to the battery module 140. When the charged voltage of the battery module 140 is less than the over-discharge reference voltage data stored in the memory 170, the distribution controller 220 controls the cut-off of the DC power from the solar cell module 120 to the battery module 140.

When the charged voltage of the battery module 140 is less than the over-charge reference voltage data stored in the memory 170, the distribution controller 220 controls the supply of the DC power from the solar cell module 120 to the battery module 140. When the charged voltage of the battery module 140 is more than or equal to the over-charge reference voltage data stored in the memory 170, the distribution controller 220 controls the cut-off of the DC power from the solar cell module 120 to the battery module 140.

The AC output driver 230 converts charged power of the battery module 140 or the DC power from the solar cell module 120 into AC power having frequency of 400 Hz to 1200 Hz and outputs the AC power to a load.

### INDUSTRIAL APPLICABILITY

It will be apparent to those having ordinary skill in the art to which the present invention pertains that the embodiments set forth herein will be presented only as examples of the present invention and that the present invention may be modified in many different forms on the basis of the embodiments. Therefore, the present invention should not be construed as being limited to the embodiments set forth in the detailed description of the invention, and the protection scope of the present invention should be defined only according to the technical spirit of the appended claims. Further, it should be understood that modifications, equivalents and replacements within the spirit of the present invention, defined by the appended claims, are included in the present invention.

1. A photovoltaic device compromising:
a light concentration unit for concentrating incident solar energy;
a solar cell module converting the solar energy concentrated in the light concentration unit into electrical energy and outputting direct current (DC) power;
a light amount detection unit for detecting a light amount of the solar energy;
a battery module charged by receiving the DC power from the solar cell module;
a power detection unit for detecting the DC from the solar cell module;
a first comparator comparing the DC power from the solar cell module detected by the power detection unit with a charged voltage of the battery module, and outputting a first comparison result signal;
a second comparator comparing a light amount of the solar energy detected by the light amount detection unit with reference light amount data indicating a light amount enough to be converted into the electrical energy, and outputting a second comparison result signal;
a third comparator comparing the charged voltage of the battery module with over-discharge reference voltage data, and outputting a third comparison result signal;
a fourth comparator comparing a charged voltage of the battery module with over-charge reference voltage data and outputting a fourth comparison result signal;
an auxiliary power generation unit, which operates when a light amount of the solar energy is less than the reference light amount data, rotates an AC motor or a DC motor by means of the DC power, decelerates or accelerates the number of revolutions of motive power, and generates and outputs auxiliary electrical energy;
a distribution controller for controlling the supply and cut-off of the DC power from the solar cell module to the battery module according to the first, second, third and fourth comparison result signals; and
an AC output driver converting charged power of the battery or the DC power from the solar cell module into alternating current (AC) power having a frequency of 400 Hz to 1200 Hz and outputting the AC power to a load.

2. The photovoltaic device according to claim wherein when the detected DC power is higher than a charged voltage of the battery module, the distribution controller controls the supply of the DC power from the solar cell module to the battery module, and
when the detected DC power is lower than or equal to a charged voltage of the battery module, the distribution controller controls the cut-off of the DC power from the solar cell module to the battery module.

3. The photovoltaic device according to claim 1, wherein when the detected light amount of the solar energy is more than equal to the light amount data, the distribution controller controls the supply of the DC power from the solar cell module to the battery module, and
when the detected light amount of the solar energy is less than the reference light amount data, the distribution controller controls the cut-off of the DC power from the solar cell module to the battery module.

4. The photovoltaic device according to claim 1, wherein when the charged voltage of the battery module is lower than or equal to the over-discharge reference voltage data, the distribution controller controls the supply of the DC power from the solar cell module to the battery module, and
when the charged voltage of the battery module is less than the over-discharge reference voltage data, the distribution controller controls the cut-off of the DC power from the solar cell module to the battery module.

5. The photovoltaic device according to claim I wherein when a charged voltage of the battery module is less than the over-charge reference voltage data, the distribution controller controls the supply of the DC power to the battery module, and
when a charged voltage of the battery module is more than or equal to the over-charge reference voltage data, the distribution controller controls the cut-off of the DC power to the battery module.

6. The photovoltaic device according to claim 1, wherein the photovoltaic device further comprises a memory that stores the reference light amount data, the over-discharge reference voltage data, and the over-charge reference voltage data.
